(19) United States
(12) Patent Application Publication
(10) Pub. No.: US 2007/0188288 A1
(43) Pub. Date: Aug. 16, 2007

(54) Laminated inductor

(76) Inventor: Koji Ishii, Gunma (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/703,519

(22) Filed: Feb. 7, 2007

(30) Foreign Application Priority Data
Feb. 9, 2006 (JP) 2006-032296

(51) Int. Cl. H01F 5/00

(52) U.S. Cl. 336/200

(57) ABSTRACT

One inventive aspect relates to a laminated inductor that can obtain a high Q value by necessary inductance. When the line width is e, the line thickness is t, and the distance between lines of the coil is d, respectively, the laminated inductor has an appropriate size such that the value of “a” obtained by formula a=d/e(t+d) is in the range of approximately 5 to 20. As a result, a high Q value is obtained.

### BACKGROUND OF THE INVENTION

1. Field of the Invention

The present invention relates to a laminated inductor, and more particularly, to a laminated inductor for high frequency circuit.

2. Description of the Related Technology

A high Q value in addition to inductance and self-resonant frequency that is suitable for use is desired for a laminated inductor used in a high frequency circuit for impedance matching, harmonic trap, or the like. The Q value is a numerical value that depends on the inductance. However, since the Q value decreases when a capacitance component (such as a floating capacitance) is generated in the laminated inductor per se or a packing state of the laminated inductor, one generally adopted method for increasing the Q value is to decrease the capacitance component so as to increase the Q value. This method has been disclosed documents such as JP-A-2001-23823, JP-A-2000-30946, JP-A-11-97244, and JP-A-2001-155938.

As for one technique that increases the Q value by decreasing the capacitance component via increasing the distance between lines of the coil, since a length of magnetic path becomes long as the distance between lines increases and the inductance becomes lower, the Q value is decreased. As for another technique that uses a low-dielectric material for a part of the chip, the Q value is interior to the case where the entire chip is configured of the low-dielectric material. As for another technique for using the coil of double spiral structure, since the capacitance component of the distance between the lines in the coil is reversely increased, the Q value is decreased. As for another technique for reducing an external electrode, structural strength is sacrificed due to an area decrease of the external electrode. Especially, by providing an external electrode on an mounting surface, in case of connecting the external electrode to the coil via a through hole, the Q value is decreased due to the capacitance component generated between the through hole and coil. That is, any of the techniques for increasing the Q value by decreasing the capacitance component includes a factor for decreasing the Q value. Accordingly, the increase of the Q value achieved is limited.

### SUMMARY OF CERTAIN INVENTIVE ASPECTS

Certain inventive aspects provide a laminated inductor that can obtain a high Q value by necessary inductance.

A first aspect of the invention provides a laminated inductor including a coil having a prescribed line width, line thickness, distance between lines, and a winding number. In this case, if the line width is e, the line thickness is t, and the distance between lines of the coil is d, respectively, the value of “a” obtained by formula, a=d/e(t+d), is in the range of 5 to 20.

According to the first aspect of the invention, if the line width is e, the line thickness is t, and the distance between lines of the coil is d, respectively, when the value of “a” obtained by formula, a=d/e(t+d), may be in the range of 5 to 20, the high Q value can be obtained by necessary inductance. In one embodiment, a high Q value can be obtained by setting the value of “a” to the range of approximately from 5 to 12. In another embodiment, a high Q value can be obtained by setting the value of “a” to the range of approximately from 7 to 12. In another embodiment, a high Q value can be obtained by setting. the value of “a” close to about 10.

In addition, a second aspect of the invention provides a laminated inductor including a coil having a prescribed winding number and a core that exists in an inner side of the coil. In this case, the ratio of volume of the core to volume of the coil may be in the range of 3 to 10.

According to the second aspect of the invention, when the ratio of volume of the core to volume of the coil is in the range of 3 to 10, a high Q value can be obtained by necessary inductance.

According to an embodiment of the invention, it is possible to provide the laminated inductor having a high Q value obtained by the necessary inductance.

The above and other objects, features, elements, characteristics and advantages of these inventive aspects will be more apparent from the following detailed description of preferred embodiments of the present invention with reference to the accompanying drawings.

### BRIEF DESCRIPTION OF THE DRAWINGS

FIG. 1 is a top view of a laminated inductor according to an embodiment of the present invention.

FIG. 2 is a side view of the laminated inductor shown in FIG. 1 as viewed from a width direction.

FIG. 3 is a side view of the laminated inductor shown in FIG. 1 as viewed from a length direction.

FIG. 4 is an exploded perspective view of a coil shown in FIG. 1.

FIG. 5 is a cross-sectional view taken along line x-x of FIG. 1.

FIG. 6 shows verification data of value of “a” based on the laminated inductor of 2 to 3 nH.

FIG. 7 shows verification data of value of “a” based on the laminated inductor of 3 to 4 nH.

FIG. 8 shows verification data of value of “a” based on the laminated inductor of 4 to 5 nH.

FIG. 9 shows verification data of value of “a” based on the laminated inductor of 5 to 6 nH.

FIG. 10 shows verification data of value of “a” based on the laminated inductor of 6 to 7 nH.

FIG. 11 shows verification data of value of “a” based on the laminated inductor of 7 to 9 nH.

FIG. 12 shows verification data of value of “a” based on the laminated inductor of 9 to 11 nH.

FIG. 13 shows verification data of value of “a” based on the laminated inductor of 11 to 14 nH.

FIG. 14 shows verification data of value of “a” based on the laminated inductor of 14 to 17 nH.

FIG. 15 shows verification data of value of “a” based on the laminated inductor of 17 to 21 nH.

FIG. 16 shows verification data of value of “a” based on the laminated inductor of 21 to 26 nH.

FIG. 17 shows verification data of W/L ratio based on the laminated inductor of 5.6 nH.

### DESCRIPTION OF CERTAIN EMBODIMENTS

Various aspects and features of the invention will become more fully apparent from the following description and appended claims taken in conjunction with the foregoing drawings. In the drawings, like reference numerals indicate identical or functionally similar elements. In the following description, specific details are given to provide a thorough understanding of the disclosed methods and apparatus. However, it will be understood by one of ordinary skill in the technology that the disclosed systems and methods may be practiced without these specific details.

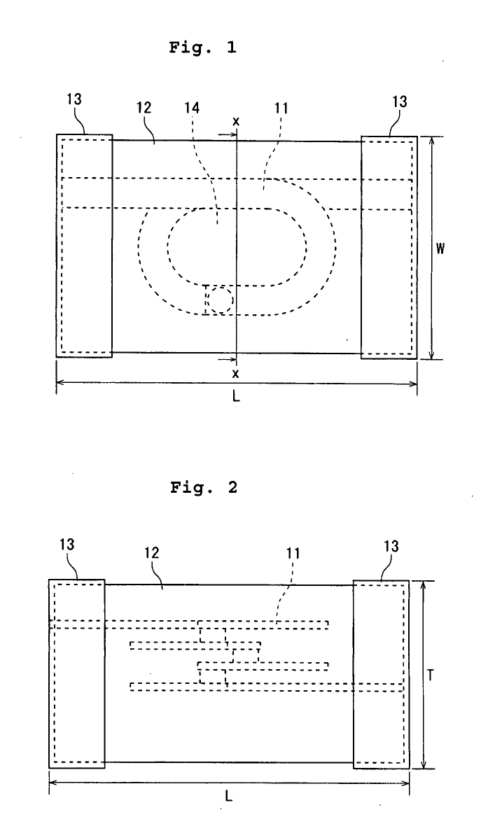

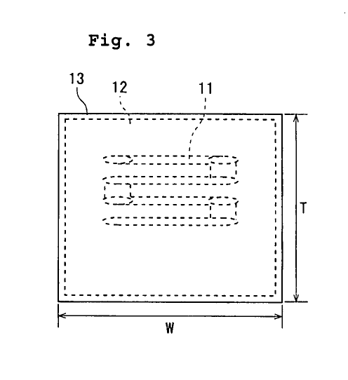

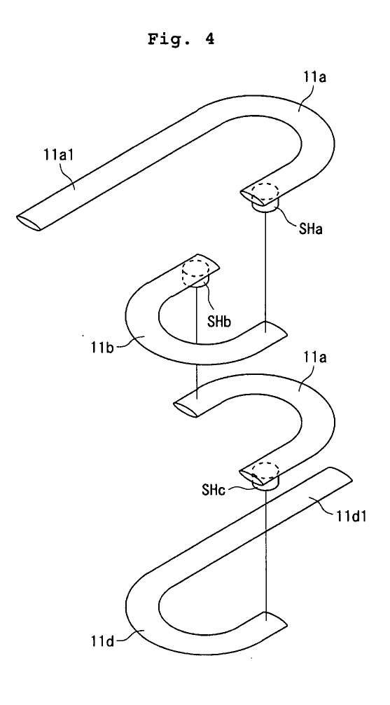

FIGS. 1 to 5 show an embodiment of the invention. FIG. 1 is a top view of a laminated inductor, FIG. 2 is a side view of the laminated inductor shown in FIG. 1 as viewed from a width direction, FIG. 3 is a side view of the laminated inductor shown in FIG. 1 as viewed from a length direction, FIG. 4 is an exploded perspective view of a coil shown in FIG. 1, and FIG. 5 is a cross-sectional view taken along line x-x of FIG. 1.

The laminated inductor shown in FIGS. 1 to 5 includes a chip 12 of a rectangular solid shape containing a cylindrical coil 11 and a pair of outer electrodes 13 provided at both ends in a length direction of the chip 12 so as to conduct with drawn parts of both ends of the coil 11.

As shown in FIGS. 1 to 3, a reference character L indicates a length of the laminated inductor, a reference character W indicates a width of the inductor, and a reference character T indicates a height of the inductor. As an example of specific numerical values, the length L is about 1.00±0.05 mm, the width W is about 0.65±0.05 mm, and the height T is about 0.50±0.05 mm. Since a thickness of the outer electrodes 13 is several tens of μm, the length, width, and height of the chip has a value approximate to the above-described length L, width W, and height T.

As shown in FIG. 4, the coil 11 has a structure such that four unit conductor lines 11a, 11b, 11c, and 11d are connected in the height direction via through holes SHa, SHb, and SHc. The uppermost unit conductor line 11a and the lowest unit conductor line 11d have integrally the drawn parts 11a1 and 11d1. For this reason, the end of one drawn part 11a1 is connected to one outer electrode 13, and the end of the other drawn part 11d1 is connected to the other outer electrode.

In addition, as shown in FIG. 5, a winding portion (a portion excluding the drawn portions 11a1 and 11d1) of the coil 11 has a prescribed line width “e”, line thickness “t”, and a distance “d” between lines. The practical winding number of the coil 11 shown in drawings is two, but the winding number may be adjusted depending on inductance to be needed. An inner portion of the coil 11 in the chip 12 constitutes a core 14 having approximately an oval cross-sectional shape.

Additionally, a material of the chip 12 of the laminated inductor is borosilicate glass (it may contain alumina), a material of the coil 11 is silver, and a material of the outer electrode 13 is silver. The surface of the outer electrode 13 made of silver is sequentially plated with nickel and tin.

The laminated inductor may be manufactured by, for example, (1) forming a sheet by coating slurry containing the borosilicate glass powder, an organic binder, an organic solvent and the like on a carrier film to dry, (2) forming four kinds of the unit conductor lines shown in FIG. 4 at the sheet by printing and drying a silver paste after forming a through hole as may be necessary, (3) laminating and compressing four kinds of the sheets formed with the unit conductor line and the sheet not formed with the conductor line in the prescribed order, (4) dividing the compressed sheets into part sizes, (5) baking the divided chip under prescribed conditions, (6) forming the outer electrodes by baking after coating the silver paste of the baked chip, and (7) forming sequentially a nickel plated layer and a tin plated layer on the outer electrodes.

The laminated inductor shown in FIGS. 1 to 5 is manufactured such that the value of “a” obtained by the following formula 1 is in the range of approximately 5 to 20, and, in other words, the value of “a” is fit within the range of approximately 5 to 20.
a=d/e(t+d) Formula 1
In the formula 1, character “e” represents a line width of the coil 11, “t” represents a line thickness of the coil 11, and “d” represents a distance between lines of the coil 11 (see FIG. 5).

First, the reason and background for attaining the above-described formula 1 will be explained.

The above formula 1 has been attained in consideration of the reasons that, for example, it may be structurally impossible to adjust the capacitance component of the laminated inductor to zero, it is in an opposite relation with the inductance and the capacitance, and there is a balance to the inductance and the capacitance, and therefore attention is to be paid to the ratio of the inductance to the capacitance of the laminated inductor to obtain a high Q value by necessary inductance.

For more details, the inductance L of the laminated inductor is expressed by the following formula 2 in case of the cylindrical coil.
L=kμN²S/H Formula 2
In the formula 2, character “k” represents Nagaoka coefficient, “μ” represents relative permeability, “N” represents a winding number, “S” represents a sectional area of the core, and “H” represents a length of magnetic path. In addition, capacitance C of the laminated inductor is expressed by the following formula 3.
C=εA/d Formula 3
In the formula 3, character “ε” represents specific inductive capacity, “A” represents a facing area of the conductor lines, and “d” represents a distance between the lines.

If the conductor length is p, the sectional area S of the core can be expressed by S=π(P/2πN)², and the length H of the magnetic path can be expressed by H=N(t+d). Accordingly, the formula 2 can be converted into the following formula 4.
L=(kμ/4π)×(p²/N(t+d)) Formula 4

In addition, the facing area A of the conductor lines can be expressed by A=ep, the formula 3 can be converted into the following formula 5.
C=εep/d Formula 5

That is, the ratio (L/C ratio) of the inductance to the capacitance of the laminated inductor is expressed by the following formula 6.
L/C=(kμ/4πε)×(p/N)×(d/e(t+d)) Formula 6
In the formula 6, since terms (kμ/4πμε) and (p/N) are treated as a constant, the ratio of the inductance to the capacitance of the laminated inductor is determined by a term (d/e(t+d)).

The formula 1 is derived from formula conversion as described above. In the formula 1, if the value of “a” is within the prescribed range, it is considered that the laminated inductor having a high Q value is obtained by the necessary inductance.

Next, the given range (5 to 20) in the value of “a” obtained by the formula 1 will be described with reference to a verification data of the value of “a” shown in FIGS. 6 to 16.

The values of “a” shown in FIGS. 6 to 16 were calculated by using mean value when the line width e, line thickness t, and distance d between the lines of the coil in each laminated inductor were measured at ten places by preparing two or more laminated inductors having different line width e, line thickness t, and distance d between the lines of the coil for each inductance so as to find out the peak and the distribution of the Q value. The Q value of the peak and the value of “a” were indicated in the most left column of each drawing, and the Q value that was lower than the Q value of the peak and the value of “a” were indicated in the right side. In addition, since ΔQ (%) indicates that deviation with the Q value of the peak was expressed in percentage, the ΔQ (%) was minus except for the Q value of the peak. Moreover, during estimating, it was marked with O when the ΔQ (%) is within the range of −20% of the Q value of the peak, and it was marked with X when the ΔQ (%) exceeds in −20% of the Q value of the peak. Since the threshold of −20% is based on the allowance at the minus side in case of using the Q value of the peak as a reference, if the ΔQ (%) is within the range of −20% of Q value of the peak, it is recognized in a good item allowance of the Q value.

FIG. 6 shows verification data of the value of “a” based on the laminated inductor of 2 to 3 nH. In this case, when the Q value of the peak is 89, the value of “a” is 8.0, and when the ΔQ (%) is within the range of −20%, the value of “a” is 5.0 to 15.8 in the laminated inductor used for the verification.

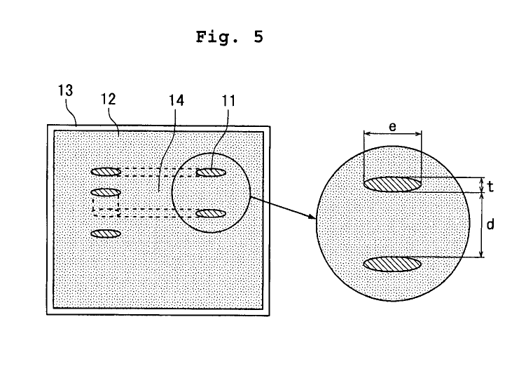

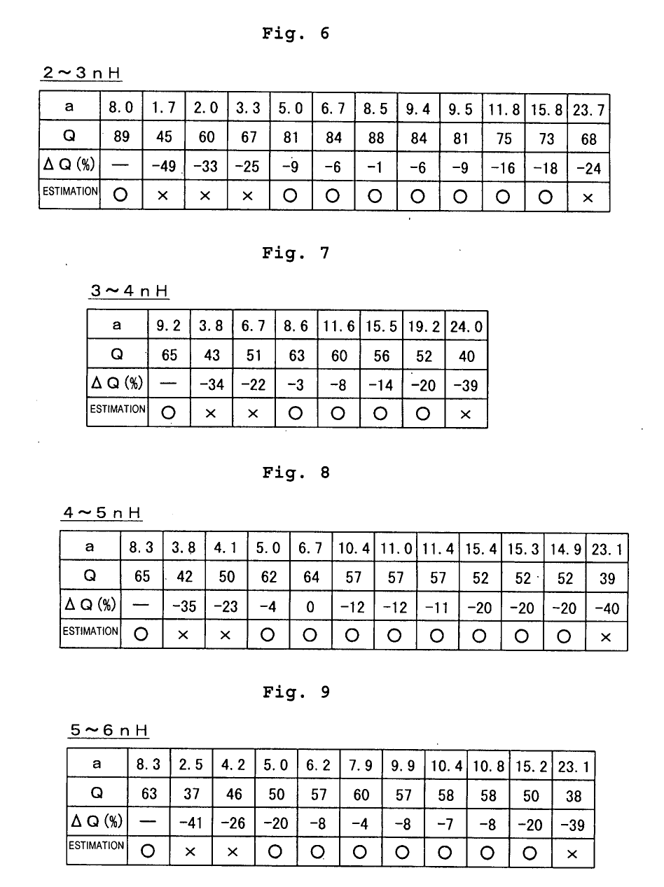

FIG. 7 shows verification data of the value of “a” based on the laminated inductor of 3 to 4 nH. In this case, when the Q value of the peak is 65, the value of “a” is 9.2, and when the ΔQ (%) is within the range of −20%, the value of “a” is 8.6 to 19.2 in the laminated inductor used for the verification.

FIG. 8 shows verification data of the value of “a” based on the laminated inductor of 4 to 5 nH. In this case, when the Q value of the peak is 65, the value of “a” is 8.3, and when the ΔQ (%) is within the range of −20%, the value of “a” is 5.0 to 14.9 in the laminated inductor used for the verification.

FIG. 9 shows verification data of the value of “a” based on the laminated inductor of 5 to 6 nH. In this case, when the Q value of the peak is 63, the value of “a” is 8.3, and when the ΔQ (%) is within the range of −20%, the value of “a” is 5.0 to 15.2 in the laminated inductor used for the verification.

FIG. 10 shows verification data of the value of “a” based on the laminated inductor of 6 to 7 nH. In this case, when the Q value of the peak is 57, the value of “a” is 10.4, and when the ΔQ (%) is within the range of −20%, the value of “a” is 5.0 to 15.4 in the laminated inductor used for the verification.

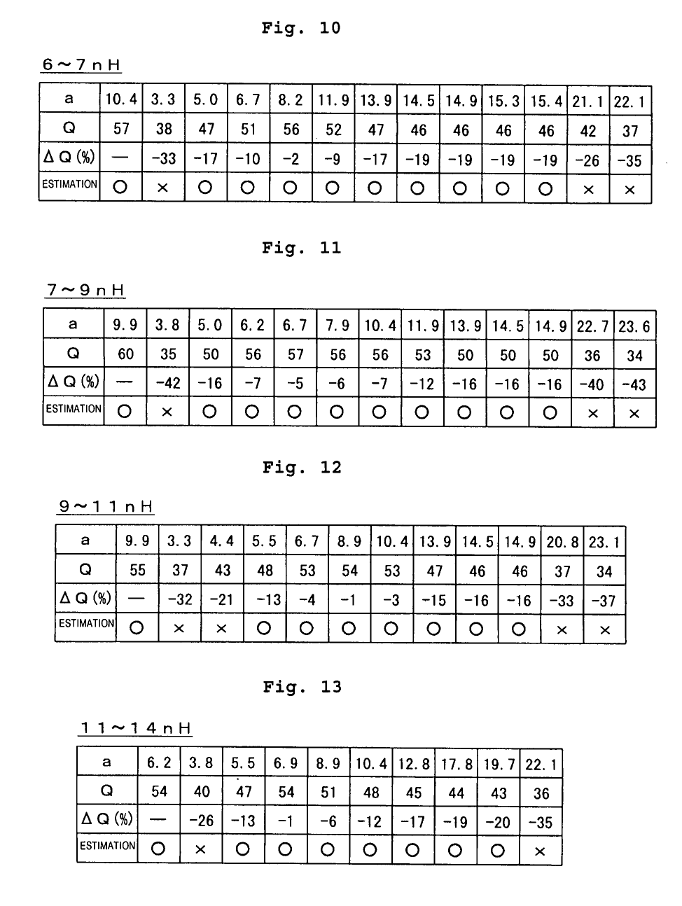

FIG. 11 shows verification data of the value of “a” based on the laminated inductor of 7 to 9 nH. In this case, when the Q value of the peak is 60, the value of “a” is 9.9, and when the ΔQ (%) is within the range of −20%, the value of “a” is 5.0 to 14.9 in the laminated inductor used for the verification.

FIG. 12 shows verification data of the value of “a” based on the laminated inductor of 9 to 11 nH. In this case, when the Q value of the peak is 55, the value of “a” is 9.9, and when the ΔQ (%) is within the range of −20%, the value of “a” is 5.5 to 14.9 in the laminated inductor used for the verification.

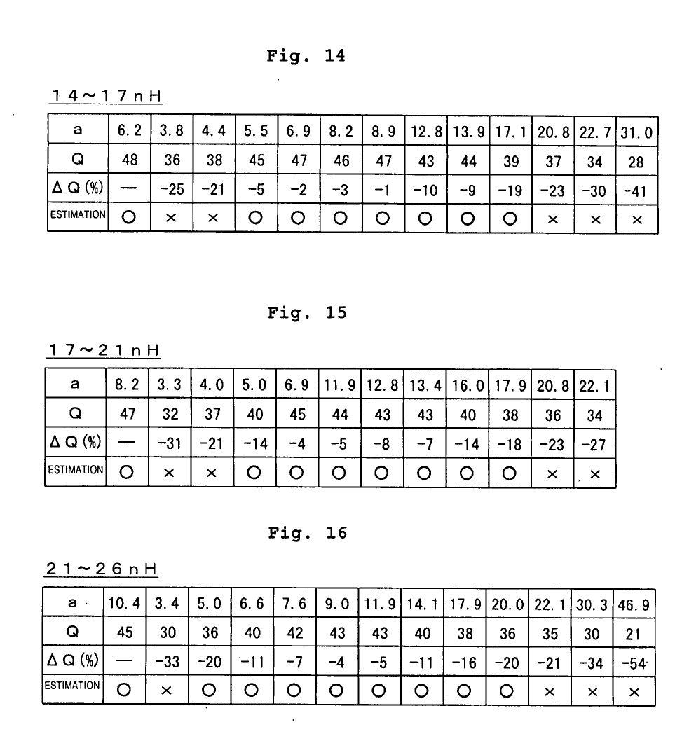

FIG. 13 shows verification data of the value of “a” based on the laminated inductor of 11 to 14 nH. In this case, when the Q value of the peak is 54, the value of “a” is 6.2, and when the ΔQ (%) is within the range of −20%, the value of “a” is 5.5 to 19.7 in the laminated inductor used for the verification.

FIG. 14 shows verification data of the value of “a” based on the laminated inductor of 14 to 17 nH. In this case, when the Q value of the peak is 48, the value of “a” is 6.2, and when the ΔQ (%) is within the range of −20%, the value of “a” is 5.5 to 17.1 in the laminated inductor used for the verification.

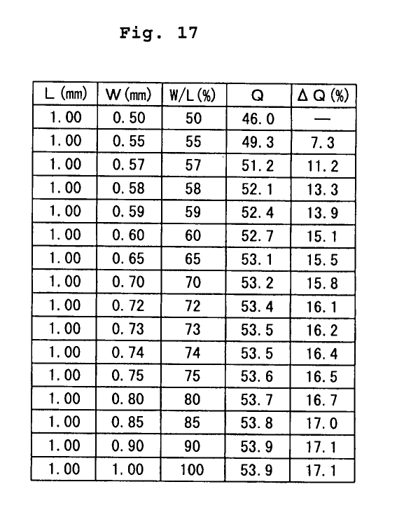

FIG. 15 shows verification data of the value of “a” based on the laminated inductor of 17 to 21 nH. In this case, when the Q value of the peak is 47, the value of “a” is 8.2, and when the ΔQ (%) is within the range of −20%, the value of “a” is 5.0 to 17.9 in the laminated inductor used for the verification.

FIG. 16 shows verification data of the value of “a” based on the laminated inductor of 21 to 26 nH. In this case, when the Q value of the peak is 45, the value of “a” is 10.4, and when the ΔQ (%) is within the range of −20%, the value of “a” is 5.0 to 20.0 in the laminated inductor used for the verification.

Though there has been a few variation in each inductance, it can be said that the Q value is within −20% of the Q value of the peak based on the verification data of FIGS. 6 to 16, if the value of “a” is roughly in the range of approximately 5 to 20. That is, a high Q value can be obtained by necessary inductance by setting the value of “a” obtained by the above-described formula 1 [a=d/e(t+d)] to the range of approximately 5 to 20. In one embodiment, a high Q value can be obtained by setting the value of “a” to the range of approximately from 5 to 12. In another embodiment, a high Q value can be obtained by setting the value of “a” to the range of approximately from 7 to 12. In another embodiment, a high Q value can be obtained by setting the value of “a” close to about 10. Though not shown in the drawings, it can be also applicable to the laminated inductors of other configurations.

The Q value of the laminated inductor may also be changed by the ratio (W/L ratio) of the width W to the length L. FIG. 17 shows the verification data of W/L ratio based on the laminated inductor of 5.6 nH. In FIG. 17, a practical winding number of coils 11 of the laminated inductor used for the verification is three, and the size in the width direction of core 14 is substantially increased in proportion to the width W of the laminated inductor.

As can be seen from FIG. 17, the Q value increases when the length L is fixed to 1.00 mm and the width W is changed from 0.50 to 1.00 mm. The ΔQ (%) indicates that the deviation with the Q value (the lowest value) was expressed in percentage when the width W is 0.50 mm. Therefore, the ΔQ (%) has plus value except that the width W is 0.50 mm. When W/L ratio (%) becomes 60% or more, the ΔQ (%) comes to exceed 15%.

That is, when W/L ratio (%) is 60% or more, it can raise the Q value by 15% or more as compared with that in case where W/L ratio (%) is 50%. In other words, if the ratio of the width W to the length L is assumed to be 0.6 or more, it is possible to further raise the Q value. When W/L ratio (%) is 80% or more, since it needs the area that corresponds to the laminated inductor of the next size up as a mounting space, a practical upper limit of W/L ratio (%) becomes 75% as a reference. Though not shown in the drawings, it can be also applicable to the laminated inductors of another configurations while there may be a few variation.

The foregoing description exemplifies the embodiment in which the value of “a” obtained by the above-described formula 1 [a=d/e(t+d)] is set to the range of approximately 5 to 20. In one embodiment, a high Q value can be obtained by setting the value of “a” to the range of approximately from 5 to 12. In another embodiment, a high Q value can be obtained by setting the value of “a” to the range of approximately from 7 to 12. In another embodiment, a high Q value can be obtained by setting the value of “a” close to about 10.

Also, a high Q value can be obtained by necessary inductance by setting the ratio of the volume of the core 14 to the volume of the coil 11 in the laminated inductor to the range of approximately 3 to 10. The volume of the core 14 can be obtained by the sectional area S of the core×the length H of the magnetic path, and the volume of the coil 11 can be obtained by the line width e×the line thickness t×the conductor length p of the coil 11. Therefore, the ratio of the volume of the core 14 to the volume of the coil 11 in the laminated inductor may be simply obtained.

The foregoing description details certain embodiments of the invention. It will be appreciated, however, that no matter how detailed the foregoing appears in text, the invention may be practiced in many ways. It should be noted that the use of particular terminology when describing certain features or aspects of the invention should not be taken to imply that the terminology is being re-defined herein to be restricted to including any specific characteristics of the features or aspects of the invention with which that terminology is associated.

While the above detailed description has shown, described, and pointed out novel features of the invention as applied to various embodiments, it will be understood that various omissions, substitutions, and changes in the form and details of the device or process illustrated may be made by those skilled in the technology without departing from the spirit of the invention. The scope of the invention is indicated by the appended claims rather than by the foregoing description. All changes which come within the meaning and range of equivalency of the claims are to be embraced within their scope.

What is claimed is:

1. A laminated inductor comprising:
a coil having a line width e, line thickness t, and distance between lines d, wherein the value of “a” obtained by a formula, a=d/e(t+d), is in the range of approximately 5 to 20.

2. The laminated inductor of claim 1, wherein the laminated inductor has a rectangular solid shape having a prescribed length and width, and wherein the ratio of the width to the length is approximately 0.6 or more.

3. The laminated inductor of claim 1, wherein the value of “a” is in the range of approximately 5 to 12.

4. The laminated inductor of claim 3, wherein the value of “a” is in the range of approximately 7 to 12.

5. The laminated inductor of claim 4, wherein the value of “a” is close to about 10.

6. The laminated inductor of claim 1, further comprising a core located in an inner side of the coil, wherein the ratio of the volume of the core to the volume of the coil is in the range of approximately 3 to 10.

7. A laminated inductor comprising:
a coil; and
a core located in an inner side of the coil,
wherein the ratio of the volume of the core to the volume of the coil is in the range of approximately 3 to 10.

8. The laminated inductor of claim 7, wherein, the laminated inductor has a rectangular solid shape having a prescribed length and width, and wherein the ratio of the width to the length is approximately 0.6 or more.
